(19) United States
(12) Patent Application Publication
(10) Pub. No.: US 2024/0303070 A1
(43) Pub. Date: Sep. 12, 2024

(54) SENSOR, ASSOCIATED METHOD AND NETWORK

(71) Applicant: Aktiebolaget SKF, Göteborg (SE)

(72) Inventors: Clément POULAILLEAU, Amboise (FR); Robin TRIOUX, Tours (FR)

(21) Appl. No.: 18/592,987

(22) Filed: Mar. 1, 2024

(30) Foreign Application Priority Data
Mar. 8, 2023 (DE) 102023202071.8

(51) Int. Cl. G06F 8/65

(52) U.S. Cl. CPC G06F 8/65

(57) ABSTRACT

A sensor (4, 5) includes a first memory (8, 9) for storing a software. A communication means (12, 13) receives a first data frame (S6) requesting an update of the current version of the software stored in the first memory (8, 9). The first data frame (S6) includes a header and data for updating the current version of the software. The header includes a first identifier and a second identifier. A second memory (10, 11) stores a predetermined sensor identifier (ID1, ID2). A comparing means (14, 15) compares the first identifier with the predetermined sensor identifier (ID1, ID2). A processing means (16, 17) updates the current version of the software from the data of the first data frame when the first identifier includes the predetermined sensor identifier (ID1).

### CROSS-REFERENCE TO RELATED APPLICATION

This application claims priority to German Application No. 102023202071.8, filed Mar. 8, 2023, the entirety of which is hereby incorporated by reference.

### FIELD

The present disclosure is directed to a sensor.

More particularly, the present disclosure deals with updating a software stored in a memory of a sensor.

### BACKGROUND

Generally, a network may comprise a plurality of sensors communicating wirelessly with a gateway to transmit measurements.

The sensors may have different hardware versions.

A first sensor may have a first hardware and comprises a memory storing a first version of a software implementing the first hardware.

The first hardware is compatible with only the first version of the software.

The software may be a firmware.

In a mesh network, during an update of the software, the gateway transmits an update request to the plurality of sensors comprising a current version of the software.

At the reception of the request, each sensor updates the current version of the software stored in its memory.

If the current version of the software is not compatible with the first hardware, the first sensor may not work properly so that measurements sent by the first sensor are not certified or the first sensor may be defect.

### SUMMARY

Consequently, the present disclosure intends to prevent the update of a software stored in a memory of the sensor having a hardware not compatible with the updated software.

According to an aspect a method for updating a software stored in a first memory of a sensor is proposed.

The method comprises:
receiving a first data frame requesting an update of the current version of the software stored in the first memory, the first data frame comprising a header and data for updating the current version of the software, the header comprising a first identifier and a second identifier,
comparing the first identifier with a predetermined sensor identifier stored in a second memory of the sensor, and
updating the current version of the software from the data of the first data frame when the first identifier includes the predetermined sensor identifier.

The current software version stored in the sensor is updated only when the updated software version is compatible with the hardware of sensor identified by the predetermined sensor identifier to avoid a malfunctioning or a defect of the said sensor.

Preferably, updating the current version of the software comprises:
replacing the current version of the software by the data in the first memory
resetting the sensor when the current version of the software is replaced by the data in the first memory, and
transmitting a second data frame comprising the second identifier when the sensor is reset.

Advantageously, when the first identifier does not include the predetermined sensor identifier, the method comprises transmitting a third data frame representative of the non-update of the software.

According to another aspect, a sensor is proposed.

The sensor comprises:
a first memory configured to store a software,
communication means configure to receive a first data frame requesting an update of the current version of the software stored in the first memory, the first data frame comprising a header and data for updating the current version of the software, the header comprising a first identifier and a second identifier
a second memory configured to store a predetermined sensor identifier,
comparing means configured to compare the first identifier with the predetermined sensor identifier, and
processing means configured to update the current version of the software from the data of the first data frame when the first identifier includes the predetermined sensor identifier.

Advantageously, the processing means are configured to:
replace the current version of the software stored in the first memory by the data in the first memory,
reset the sensor when the current version of the software is replaced by the data in the first memory, and
transmit a second data frame comprising the second identifier when the sensor is reset.

Preferably, the processing means are configured to transmit a third data frame representative of the non-update of the software when the first identifier does not include the predetermined sensor identifier.

According to another aspect, a network is proposed.

The network comprises:
a gateway,
at least one sensor as previously defined, the communication means being configured to communicate wirelessly with the gateway,
the gateway being configured to send the first data frame.

Advantageously, the gateway is further configured to receive at least the second data frame transmitted by the processing means of the sensor.

Preferably, the network further comprises a network supervisor configured to monitor the update of the software from data frame transmitted by the processing means of the sensor.

Advantageously, the network is a mesh network.

### BRIEF DESCRIPTION OF THE DRAWINGS

Other advantages and features of the present disclosure will appear on examination of the detailed description of embodiments, in no way restrictive, and the appended drawings in which:

FIG. 1 illustrates schematically an example of a network according to the present disclosure; and

FIGS. 2 to 5 illustrate an example implementing the example of the network according to the present disclosure.

### DETAILED DESCRIPTION

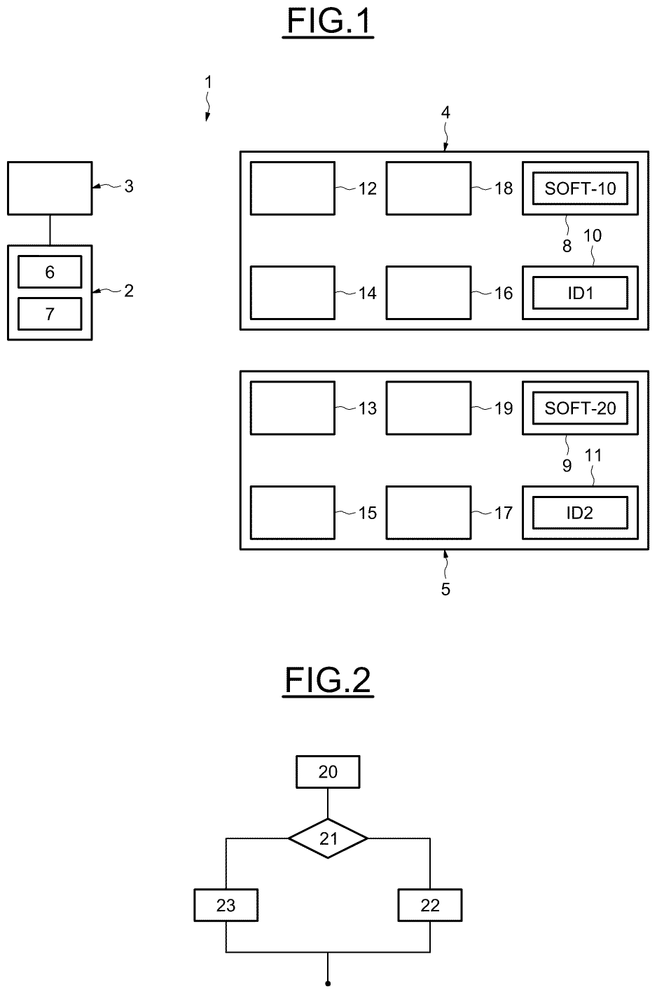

Reference is made to FIG. 1 which represents an example of a network 1 comprising a gateway 2, a network supervisor 3 connected to the gateway 2, a first sensor 4, and a second sensor 5.

The network 1 is a star mesh.

In variant, the network 1 comprises more than two sensors.

The gateway 2 comprises emission means 6 and reception means 7.

Each sensor of the first and second sensors 4, 5 comprises a first memory 8, 9, a second memory 10, 11, communication means 12, 13, comparing means 14, 15, and processing means 16, 17.

The first and second sensors 4, 5 are implemented by the processing means 16, 17 from a software, for example a firmware.

The first memory 8 of the first sensor 4 stores a first version SOFT-10 of the software, and the first memory 9 of the second sensor 5 stores a second version SOFT-20 of the software.

The first version SOFT-10 of the software is the current version of the software implemented by the first sensor 4, and the second version SOFT-20 of the software is the current version of the software implemented by the second sensor 5.

The second memory 10 of the first sensor 4 stores a first predetermined sensor identifier ID1, and the second memory 11 of the second sensor 5 stores a second predetermined sensor identifier ID2.

The first and second predetermined sensor identifiers ID1, ID2 are assigned to the sensors 4, 5 during their manufacturing.

The first and second predetermined sensor identifiers ID1, ID2 represent the version of the hardware of the first and second sensors 4, 5.

The second memories 10, 11 may be non-volatile memories.

The hardware version of the first sensor 4 identified by the first predetermined sensor identifier ID1 is implemented by the first version SOFT-10 of the software, and the hardware version of the second sensor 5 identified by the second predetermined sensor identifier ID2 is implemented by the second version SOFT-20 of the software.

The communication means 12, 13 of the first and second sensors 4, 5 communicate with the emission means 6 and reception means 7 of the gateway 2.

Each sensor of the first and second sensors 4, 5 further comprises measuring means 18, 19.

The measurement means 18, 19 of the first and second sensors 4, 5 comprise each for example a measurement interface measuring the temperature outside the said sensor 4, 5 and/or measuring the vibration of a machine on which the sensor 4, 5 is fixed.

Each processing means 16, 17 of the first and second sensors 4, 5 comprise for example a processing unit implementing the first memory 8, 9, the second memory 10, 11, the communication means 12, 13, the comparing means 14, 15, and the measurement means 18, 19.

The first and second sensors 4, 5 and the gateway 2 may communicate wirelessly, for example using a Mesh protocol or a Bluetooth protocol.

In variant, the first and second memories 8, 9, 10, 11 of each sensor 4, 5 may be one memory.

FIGS. 2 to 5 illustrate an example implementing the example of network 1 for updating the software stored in the first memory 8, 9 of the first and second sensors 4, 5.

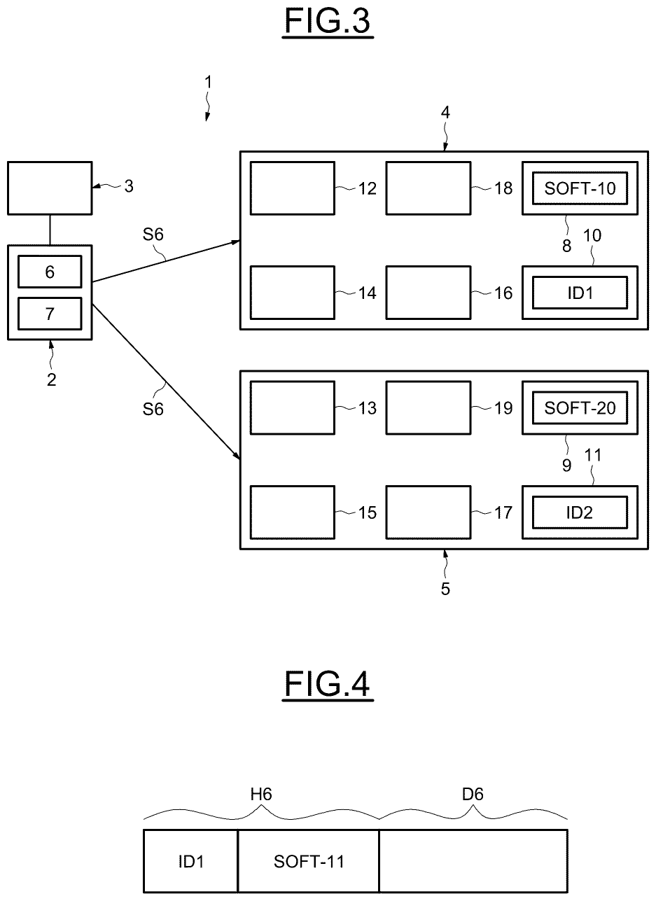

In a first step 20 (FIG. 2), the emission means 6 of the gateway 2 send a first data frame S6 requesting an update of the software as illustrated on FIG. 3.

FIG. 4 illustrates schematically an example of the first data frame S6.

The first data frame S6 comprises a header H6 comprising a first identifier and a second identifier, and data D6 for updating the software.

The first identifier represents the version of the hardware compatible with the update of the software, and the second identifier represents the version of the software.

It is assumed that the update of the software is compatible with the hardware version identified by the first predetermined sensor identifier ID1 so that the first identifier of the first data frame S6 is ID1.

It is assumed that the software update version is identified by the second identifier SOFT-11.

In a step 21 (FIG. 2), when the communication means 12 of the first sensor 4 receive the first data frame S6, the comparing means 14 of the first sensor 4 compare the first predetermined sensor identifier ID1 stored in the first memory 8 of the first sensor 4 to the first identifier ID1 of the first data frame S6.

As the first predetermined sensor identifier ID1 of the first sensor 4 is identical to the first identifier ID1 of the first data frame S6, in a step 22, the processing means 16 of the first sensor 4 proceed to the update of the current version of the software stored in the second memory 10 of the first sensor 4 from the data D6 of the first data frame S6.

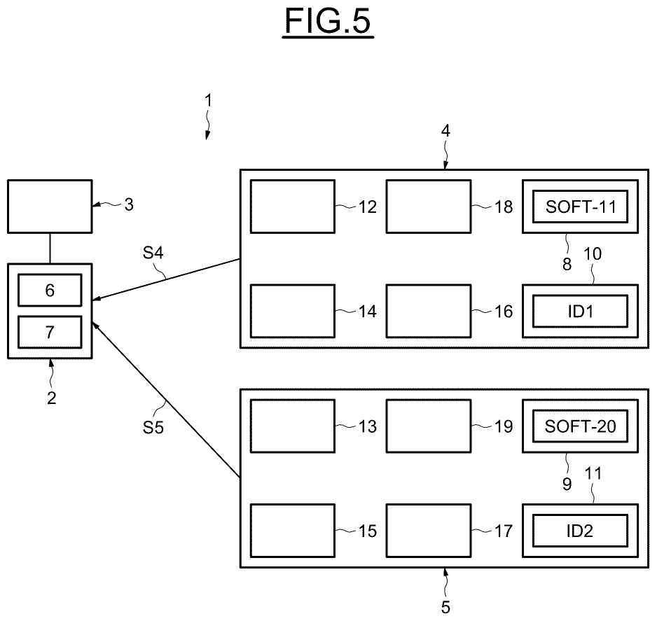

The processing means 16 replace the current version SOFT-10 of the software by the data of the data frame S6 in the first memory 8 so that the version SOFT-11 of the software is stored in the first memory 8 of the first sensor 4 (FIG. 5).

When the current version SOFT-10 of the software stored in the first memory 8 is replaced by the data D6 of the first data frame S6 in the first memory 8, the processing means 16 reset the first sensor 4 to set up the software update.

When the first sensor 4 is reset, the communication means 12 of the first sensor 4 transmit a second data frame S4 comprising the second identifier SOFT-11 of the first data frame S6.

Similarly, in the step 21 (FIG. 2), when the communication means 13 of the second sensor 5 receive the first data frame S6, the comparing means 15 of the second sensor 5 compare the first predetermined sensor identifier ID2 stored in the first memory 9 of the second sensor 5 to the first identifier ID1 of the first data frame S6.

As the second predetermined sensor identifier ID2 of the second sensor 5 and the first identifier ID1 of the first data frame S6 are different, the processing means 17 of the second sensor 5 do not proceed to the update of the current version of the software stored in the second memory 11 of the second sensor 5.

In a step 23, the communication means 13 of the second sensor 5 transmit transmitting a third data frame S5 representative of the non-update of the software stored in the in the first memory 9 of the second sensor 5 (FIG. 5).

The second data frame S4 and the third data frame S5 may be transmitted by the gateway 2 to the network supervisor 3.

The network supervisor 3 collects the second data frame S4 and the third data frame S5 transmit by the plurality of sensors 4, 5 to monitor the update of the software of the plurality of sensors 4, 5 of the network 1.

The network supervisor 3 may comprise a human machine interface, for example a display interface (not represented), to inform a user of the network 1 about the update status of each sensor 4, 5 of the network 1.

The presented method for updating the software stored in the sensors 4, 5 prevents to update a sensor 4, 5 with a software version, for example a firmware version, that is not compatible with the said sensor 4, 5 to avoid a malfunctioning or a defect of the said sensor.

In another example, the first identifier of the header H6 of first data frame S6 comprises a range of identifiers representing a plurality of versions of the hardware compatible with the update of the software so that the current version of the software of sensors having predetermined sensor identifiers included in the range of identifiers of the first identifier of the header H6 is updated at the reception of the first data frame S6.

It is for example assumed that the first identifier of the header H6 comprises the first predetermined sensor identifier ID1 and the second predetermined sensor identifier ID2.

In step 22, as the first predetermined sensor identifier ID1 of the first sensor 4 and the second predetermined sensor identifier ID2 of the second sensor 5 are included in the first identifier of the first data frame S6, in the step 22, the processing means 16 of the first sensor 4 proceed to the update of the current version of the software stored in the second memory 10 of the first sensor 4 from the data D6 of the first data frame S6, and the processing means 17 of the second sensor 5 proceed to the update of the current version of the software stored in the second memory 11 of the second sensor 5 from the data D6 of the first data frame S6.

The presented method for updating the software further allows to update different versions of hardware implemented in sensors by transmitting only one first data frame S6 to the plurality of sensors so that only the current version of the software of the sensors having a hardware compatible with the updated software is updated.

What is claimed is:

1. A method for updating a software stored in a first memory of a sensor, comprising:
receiving a first data frame requesting an update of the current version of the software stored in the first memory, the first data frame comprising a header and data for updating the current version of the software, the header comprising a first identifier and a second identifier,
comparing the first identifier with a predetermined sensor identifier stored in a second memory of the sensor, and
updating the current version of the software from the data of the first data frame when the first identifier includes the predetermined sensor identifier.

2. The method according to claim 1, wherein updating the current version of the software comprises:
replacing the current version of the software by the data in the first memory,
resetting the sensor when the current version of the software is replaced by the data in the first memory, and
transmitting a second data frame comprising the second identifier when the sensor is reset.

3. The method according to claim 1, wherein when the first identifier does not include the predetermined sensor identifier, the method comprises transmitting a third data frame representative of the non-update of the software.

4. The method according to claim 2, wherein when the first identifier does not include the predetermined sensor identifier, the method comprises transmitting a third data frame representative of the non-update of the software.

5. A sensor comprising:
a first memory configured to store a software,
communication means configure to receive a first data frame requesting an update of the current version of the software stored in the first memory, the first data frame comprising a header and data for updating the current version of the software, the header comprising a first identifier and a second identifier,
a second memory configured to store a predetermined sensor identifier,
comparing means configured to compare the first identifier with the predetermined sensor identifier, and
processing means configured to update the current version of the software from the data of the first data frame when the first identifier includes the predetermined sensor identifier.

6. The sensor according to claim 5, wherein the processing means are configured to:
replace the current version of the software stored in the first memory by the data in the first memory,
reset the sensor when the current version of the software is replaced by the data in the first memory, and
transmit a second data frame comprising the second identifier when the sensor is reset.

7. The sensor according to claim 5, wherein the processing means are configured to transmit a third data frame representative of the non-update of the software when the first identifier does not include the predetermined sensor identifier.

8. The sensor according to claim 6, wherein the processing means are configured to transmit a third data frame representative of the non-update of the software when the first identifier does not include the predetermined sensor identifier.

9. A network comprising:
a gateway,
at least one sensor according to claim 5, the communication means being configured to communicate wirelessly with the gateway,
the gateway being configured to send the first data frame.

10. A network comprising:
a gateway,
at least one sensor according to claim 6, the communication means being configured to communicate wirelessly with the gateway,
the gateway being configured to send the first data frame,
wherein the gateway is further configured to receive at least the second data frame transmitted by the processing means of the sensor.

11. The network according to claim 9, further comprising a network supervisor configured to monitor the update of the software from data frame transmitted by the processing means of the sensor.

12. The network according to claim 9, wherein the network is a mesh network.

13. A network comprising:
a gateway,
at least one sensor according to claim 8, the communication means being configured to communicate wirelessly with the gateway,
the gateway being configured to send the first data frame.

14. The network according to claim 13, wherein the gateway is further configured to receive at least the second data frame transmitted by the processing means of the sensor.

15. The network according to claim 13, further comprising a network supervisor configured to monitor the update of the software from data frame transmitted by the processing means of the sensor.

16. The network according to claim 15, wherein the network is a mesh network.
